(19) United States
(12) Patent Application Publication
(10) Pub. No.: US 2026/0008625 A1
(43) Pub. Date: Jan. 8, 2026

(54) CONVEYOR BELT DRIVE SYSTEM AND CONFIGURATION

(71) Applicant: Dematic Corp., Grand Rapids, MI (US)

(72) Inventors: Harry T. German, Belding, MI (US); Tyler Ernest, Cedar Springs, MI (US); Spencer Knizacky, Grand Rapids, MI (US); Joseph Russell, Jenison, MI (US); Travis Smith, Comstock Park, MI (US)

(21) Appl. No.: 18/763,423

(22) Filed: Jul. 3, 2024

(51) Int. Cl. B65G 23/04; B65G 23/44

(52) U.S. Cl. CPC B65G 23/04; B65G 23/44

(57) ABSTRACT

A conveyor assembly includes a belt drive system comprising a plurality of rollers mounted between side frames and about which a belt is disposed with the plurality of rollers comprising a driven roller, a tension roller and a plurality of conveyor rollers. The tension roller is mounted to the side frames by a tension assembly mount comprising a tensioner assembly. The tensioner assembly comprises a housing having a channel within which a slide mount is disposed for movement with the housing including an elongate opening at the channel with the tension roller including a shaft that is engaged with the slide mount at the elongate opening. The tensioner assembly further comprises a biasing member configured to apply a force to the slide mount to thereby bias the tension roller into engagement with the belt for applying a tension force to the belt about the plurality of rollers.

### BACKGROUND AND FIELD OF THE INVENTION

The present invention is directed to a drive system for a belt conveyor, and in particular a drive system employing a driven roller and a belt roller tensioner assembly.

Belt conveyors are employed for conveying items, where belts are disposed around rollers. The rollers may include motorized rollers for driving the belts, where the motorized rollers are disposed at the conveyance plane of the conveyor. The belts of the conveyor may be disposed over multiple rollers or may be disposed over slider pans to define a conveying surface.

### SUMMARY OF THE INVENTION

The present invention provides a conveyor assembly having one or more belt drive systems that utilize a driven roller for driving the conveyor belt and include tensioner assemblies for imparting tension to the belt.

According to an aspect of the present invention, a conveyor assembly having a conveyor belt for conveying articles comprises a pair of side frames to which a belt drive system is mounted, where the belt is driven by the belt drive system between the side frames. The belt drive system comprises a plurality of rollers mounted between the side frames and about which the belt is disposed with the plurality of rollers comprising a driven roller, a tension roller and a plurality of conveyor rollers. The tension roller is mounted to the side frames by a tension assembly mount comprising a tensioner assembly, where the tensioner assembly comprises a housing having a channel within which a slide mount is disposed for movement, with the housing including an elongate opening at the channel, and where the tension roller includes a shaft and an end of the shaft is engaged with the slide mount at the elongate opening. The tensioner assembly further comprises a biasing member configured to apply a force to the slide mount to thereby bias the tension roller into engagement with the belt for applying a tension force to the belt about the plurality of rollers.

In accordance with particular embodiments, the tensioner assembly further comprises an adjustment shaft coupled to the biasing member for selectively adjusting the force applied to the slide mount. The tensioner assembly may further comprise a bracket to which the housing is mounted with the bracket being mounted to one of the side frames, where the bracket comprises an elongate opening aligned with the elongate opening of the housing, and where the adjustment shaft may be mounted to the bracket.

Still further, the tensioner assembly can comprise a pair of tensioner assemblies, such as a first and second tensioner assembly that are mounted to respective side frames with the tension roller mounted to and between the first and second tensioner assembly. The tensioner assemblies may be similarly configured. The side frames of the conveyor each include elongate apertures where the first and second tensioner assemblies are mounted to the respective side frames at the elongate apertures of the side frames with the shaft of the tension roller engaging with the first and second tensioner assemblies through the elongate apertures of the side frames.

In particular embodiments the plurality of conveyor rollers comprises at least two end conveyor rollers between which the belt defines a conveying surface, and the driven roller presses against an outer surface of the belt and the tension roller presses against an inner surface of the belt. The conveyor may include a plurality of belt drive systems.

According to another aspect of the present invention, a belt drive system for driving a belt of a conveyor comprises a plurality of rollers configured to be mounted between a pair of side frames of a conveyor and about which a belt is disposed with the plurality of rollers comprising a driven roller, a tension roller and a plurality of conveyor rollers, and includes a tension assembly mount for mounting the tension roller between the side frames, where the tension assembly comprises a tensioner assembly, such as at least one tensioner assembly or a pair of tensioner assemblies with a respective one on each of the two side frames. The tensioner assembly comprises a housing having a channel within which a slide mount is disposed for movement, with the housing including an elongate opening at the channel, and with the tension roller including a shaft where an end of the shaft is engaged with the slide mount at the elongate opening. The tensioner assembly further comprises a spring configured to apply a force to the slide mount to thereby bias the tension roller into engagement with the belt for applying a tension force to the belt about the plurality of rollers.

In accordance with particular embodiments, the tensioner assembly further comprises an adjustment shaft coupled to the spring for selectively adjusting the force applied to the slide mount. The tensioner assembly may further comprise a bracket to which the housing is mounted with the bracket being mounted to one of the side frames, where the bracket comprises an elongate opening aligned with the elongate opening of the housing, and where the adjustment shaft may be mounted to the bracket.

In the configuration in which a tensioner assembly is mounted to each of the side frames to comprise first and second tensioner assemblies, a tension roller is mounted to and between the first and second tensioner assemblies, where the first tensioner assembly is configured to be mounted to one of the side frames and the second tensioner assembly is configured to be mounted to the other of the side frames.

Still further, the plurality of conveyor rollers may include at least two end conveyor rollers between which the belt defines a conveying surface, and the driven roller may press against an outer surface of the belt and the tension roller may press against an inner surface of the belt. In a particular configuration a belt projection extends from the inner surface of the belt with each of the tension roller and the conveyor rollers including a groove within which the belt projection is configured to ride. The belt drive system may further include an idler roller about which the belt is disposed.

According to yet another aspect of the present invention, a tension assembly mount assembly for applying a biasing force to a belt of a conveyor comprises at least one tensioner assembly. The tensioner assembly comprises a housing having a channel within which a slide mount is disposed for movement, with the housing including an elongate opening at the channel, and where the slide mount is configured to receive an end of a shaft of a tension roller at the elongate opening. The tensioner assembly further comprises a spring configured to apply a force to the slide mount to thereby bias the tension roller into engagement with a belt for applying a tension force to the belt.

In accordance with particular embodiments the tension assembly mount includes an adjustment shaft coupled to the spring for selectively adjusting the force applied to the slide mount, and may further include a bracket to which the housing is mounted with the bracket comprising an elongate opening aligned with the elongate opening of the housing. The adjustment shaft may be configured as a threaded shaft and may be mounted to the bracket with the bracket in turn being configured for mounting to a side frame of a conveyor.

The housing may further include an outer aperture through which the slide mount is visible for observing the position of the slide mount within the housing. Still further, a spring slide may be disposed within the channel of the housing with the spring being disposed between the slide mount and the spring slide with the threaded shaft engaging with the spring slide to selectively adjust the force applied to the slide mount via the spring. The tension assembly mount may comprise a first tensioner assembly and a second tensioner assembly configured for mounting a tension roller therebetween with the tensioner assemblies being mounted to respective side frames.

The drive systems beneficially enable objects to be transported by belt conveyors with reduced tension on the belt, thereby requiring less power to operate the conveyor and reducing the stress on the various rollers, including driven roller, and increasing the useful life of the components of conveyor. The drive system also provides a standardized system in connection with side frames of the conveyor, thereby reducing the cost and providing a conveyor that is more flexible in different uses and applications. These and other objects, advantages, purposes and features of this invention will become apparent upon review of the following specification in conjunction with the drawings.

### BRIEF DESCRIPTION OF THE DRAWINGS

FIG. 1 is a top partial perspective view of a conveyor assembly in accordance with the present invention shown with the conveyor belt removed;

FIG. 2A is a side elevation view of the conveyor assembly of FIG. 1 illustrating the side shown in FIG. 1;

FIG. 2B is a side elevation view of the conveyor assembly of FIG. 1 shown from the opposite side relative to FIG. 2A;

FIG. 3 is a side elevation view of the conveyor assembly of FIG. 1 from the view of FIG. 2A with one of the side frames removed to illustrate a pair of belt drive systems;

FIG. 4 discloses portions of a belt drive system in accordance with the present invention shown apart from the side frames of the conveyor assembly of FIG. 1;

FIG. 5 is a side elevation view of a side frame of the conveyor assembly of FIG. 3;

FIG. 6 is an exploded perspective view of an alternative conveyor assembly in accordance with the present invention;

FIG. 7 is a front elevation view of a belt roller tensioner assembly in accordance with the present invention shown removed from a conveyor assembly;

FIG. 8 is a rear elevation view of the tensioner assembly of FIG. 7;

FIGS. 9 and 10 are exploded perspective views of the tensioner assembly of FIG. 7;

FIG. 11 is a bottom perspective view of a slide of the tensioner assembly of FIG. 7; and

FIG. 12 is a perspective view of a guide and guard bracket.

### DESCRIPTION OF THE PREFERRED EMBODIMENTS

The present invention will now be described with reference to the accompanying figures, wherein the numbered elements in the following written description correspond to like-numbered elements in the figures.

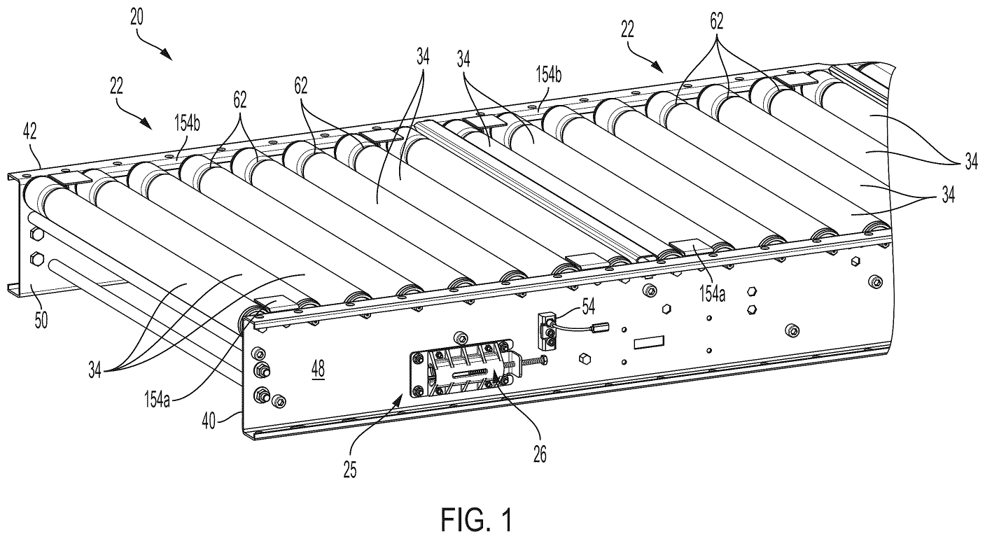

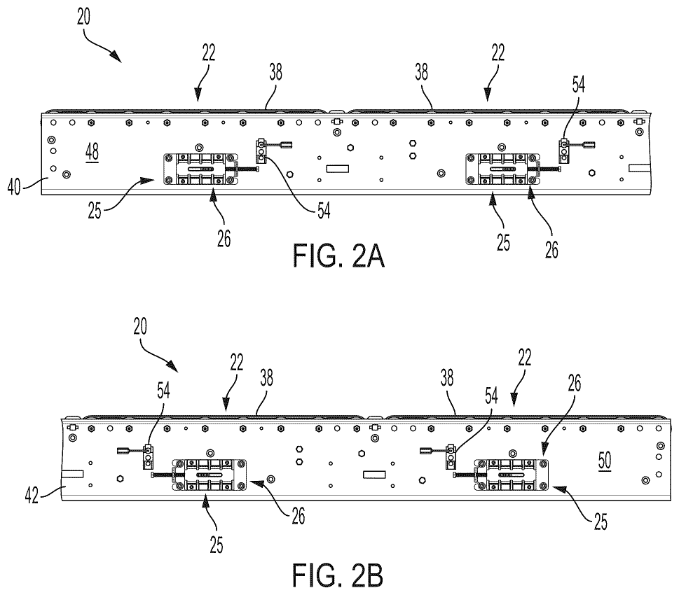

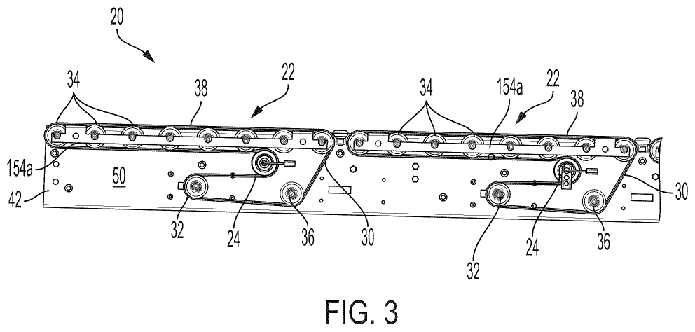

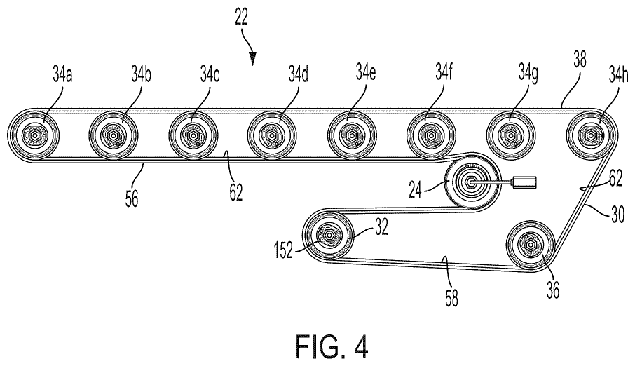

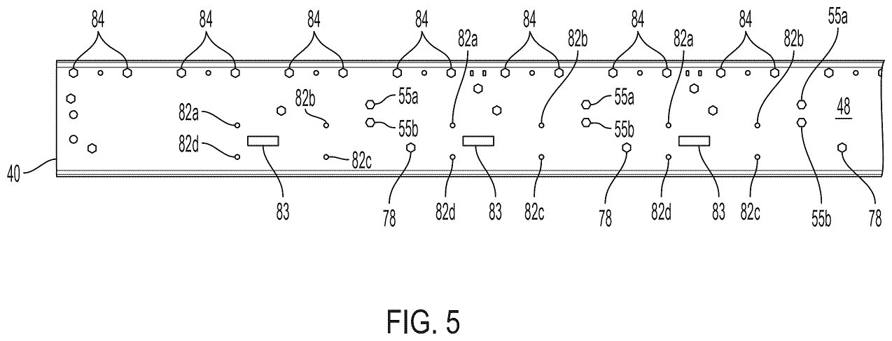

FIGS. 1-4 illustrate a conveyor 20 including belt drive systems 22 for driving conveyor belts 30 (not shown in FIG. 1, see belt 30 FIGS. 3 and 4). Each drive system 22 includes a drive or driven roller 24 and a tension assembly mount 25 comprising a pair of opposed belt tensioner assemblies 26 mounted to respective side frames 40, 42 with a tension or take-up roller 32 mounted between the tensioner assemblies 26. The conveyor belt 30 is disposed about the driven roller 24, the tension roller 32, conveyor rollers 34 and an idler roller 36. As discussed in more detail below, the tension roller 32 via the tensioner assemblies 26 imparts a desired tension to belt 30 to define or operate as a tension system or assembly for the conveyor 20, with the conveyor rollers 34 forming a conveying surface 38 for objects to be moved by conveyor 20 in a conveying direction that extends longitudinally with the conveyor 20. In addition to drive system 22 beneficially enabling objects to be transported by conveyor 20 with reduced tension on belt 30, thereby requiring less power to operate the conveyor and reducing the stress on the various rollers, including driven roller 24, and increasing the useful life of the components of conveyor 20, drive system 22 also provides a standardized system in connection with side frames 40, 42, thereby reducing the cost and providing a conveyor that is more flexible in different uses and applications.

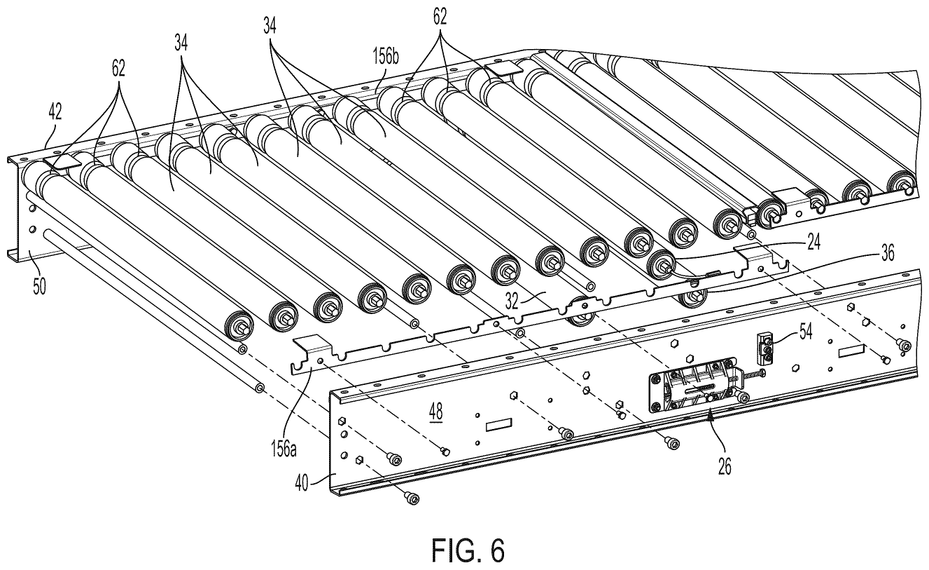

In the illustrated embodiments, driven roller 24 comprises a motorized drive roller that includes an internal motor construction for imparting driving rotation to roller 24. Roller 24 is mounted to the frame of conveyor 20, and in particular between side frames 40, 42 via roller shaft mounts 54 disposed on each of side frames 40, 42 (not shown on side frame 42). Side frames 40, 42 have generally outwardly oriented C-shaped profiles with vertical portions 48, 50, respectively, with roller shaft mounts 54 being disposed on outwardly oriented sides of the respective side frames 40, 42. In the illustrated embodiment side frame 42 is substantially similar to side frame 40 with side frame 42 having a mirror configuration of apertures as shown on side frame 40. As thus understood with reference to vertical portion 48 shown in FIG. 5, each vertical portion 48, 50 of side frames 40, 42 includes a repeating pattern of apertures at which the various components of belt drive system 22 are mounted. The apertures include pairs of aligned apertures 55a, 55b at which roller shaft mounts 54 are installed or mounted. Roller shaft mounts 54 may comprise mounts as disclosed in U.S. Pat. No. 7,243,784, which is hereby incorporated herein by reference in its entirety. Side frames 40, 42 further include apertures 78 for receiving the shaft of idler roller 36, apertures 82a-82d for mounting of tensioner assemblies 26, with side frames 40, 42 including elongate apertures 83 at which tension roller 32 is mounted as described in more detail below. Side frames 40, 42 additionally include apertures 84 at which the shafts of conveyor rollers 34 are mounted. In the illustrated embodiment apertures 78 and 84 are hexagonal for receiving the hexagonal shaped shafts of idler roller 36 and conveyor rollers 34 to thereby prevent rotation of the shafts.

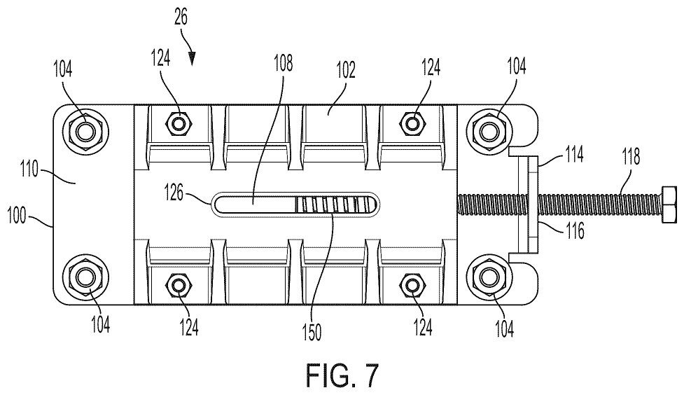

FIG. 4 illustrates portions of a belt drive system 22 removed from between side frames 40, 42 with conveyor rollers 34 comprising eight conveyor rollers 34a-34h. As there, shown, drive roller 24 presses against an outer surface or side 56 of belt 30 with the various rollers 32, 34, 36 contacting the inner surface or side 58 of belt 30. Belt 30 includes a projection 60 disposed along the inner side 58 of belt 30 that is configured to ride within grooves formed on the outer surfaces of rollers 32, 34, 36, such as grooves 62 on rollers 34 as shown in FIGS. 1 and 6. Rollers 32 and 36 also include such grooves 62. Projection 60 may have a “v” or “u” shaped cross section, or the like, that is configured to mate with the grooves 62 in the rollers 32, 34, 36 for maintaining the tracking of belt 30 on conveyor 20. As noted, although belt drive system 22 is shown as including eight conveyor rollers 34a-34h it should be appreciated that more or fewer conveyor rollers 34 may be employed in an alternative belt drive system. Still further, belt 30 may be alternatively configured to slide over a slider pan (not shown) between a pair of conveyor rollers 34, such as understood from U.S. Pat. No. 10,384,879.

FIG. 6 illustrates an embodiment of an alternative conveyor assembly 220 having twelve conveyor rollers 34 employed for each drive system 222. Alternative conveyor 220 with drive systems 222 is substantially similar to conveyor 20 and drive system 22, but with drive systems 222 being configured with twelve conveyor rollers 34. Conveyor assembly 220 utilizes side frames 40, 42 to which are mounted tensioner assemblies 26 (not shown on side frame 242). Of note, side frames 40, 42 are provided with patterns of apertures for configuring with alternative numbers of conveyor rollers 34, such as apertures 55a, 55b for mounts 54, apertures 78 for idler rollers 36, apertures 82a-82d for tensioner assemblies 26, elongate apertures 83 for tension rollers 32, as well as apertures 84 for conveyor rollers 34. In the illustrated embodiment side frames 40, 42 are thus configured to accommodate drive systems 22, 222 with either eight or 12 conveyor rollers 34. It should be appreciated that alternatively configured side frames for use with alternatively configured drive systems may be employed. Due to the similarities of conveyors 20, 220 and drive systems 22, 222 the following discussion focuses on the configuration and operation of conveyor 20 and drive system 22 but it should be appreciated that the discussion of like components in connection with conveyor 20 and drive systems 22 applies to conveyor 220 and drive system 222. It should also be appreciated that alternative conveyors with alternatively configured drive systems within the scope of the present invention may employ varying numbers of conveyor rollers 34 depending on the application requirements

As noted, tension assembly mount 25 includes the use of a tensioner assembly 26 mounted on each of side frames 40, 42 and between which tension roller 32 is mounted. It should be appreciated that due to their similarities, the present discussion focuses on the tensioner assembly 26 mounted on side frame 40. It should be appreciated that the discussion herein applies equally to the structure and operation of the tensioner assembly 26 mounted to side frame 42, which is similarly constructed and mounted in mirror fashion to side frame 42.

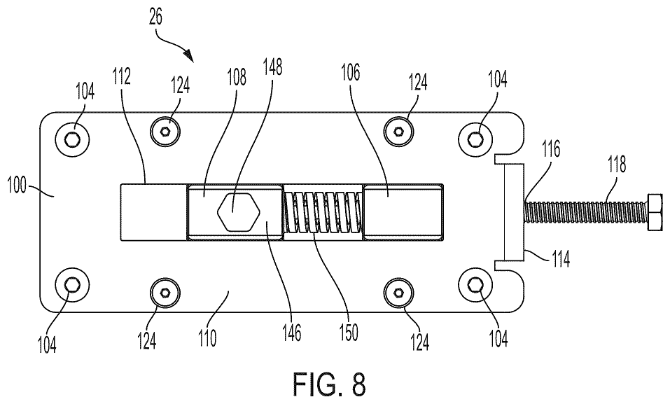

The illustrated embodiment of tensioner assembly 26 will now be discussed with reference to FIGS. 7-11. As shown, tensioner assembly 26 includes a bracket 100 to which is affixed a housing 102, with bracket 100 being mounted to side frame 40 at apertures 82a-82d via fasteners 104. Tensioner assembly 26 further includes a pair of slides 106, 108 disposed within housing 102 with, as discussed in more detail below, tension roller 32 being mounted between slides 108 of the opposed tensioner assemblies 26 mounted on side frames 40, 42.

Bracket 100 includes a base 110 that is disposed against vertical portion 48 when mounted to side frame 40, with base 110 including apertures for fasteners 104. Base 110 further includes an elongate aperture 112 for receiving slides 106, 108 within housing 102, where aperture 112 is configured to be rectangular with elongate parallel sides. Bracket 100 also includes a flange 114 that is angled or upstanding relative to base 110, with flange 114 being generally perpendicular to base 110 and extending away from side frame 140 when bracket 100 is mounted thereto. Flange 114 includes a threaded hole 116 for receiving a threaded shaft, which in the illustrated embodiment is configured as a bolt 118.

Housing 102 comprises an elongate internal passage or channel 120 that forms an opening 122 at aperture 112 of bracket 100 when housing 102 is mounted to bracket 100, such as by fasteners 124. Housing 102 additionally includes an elongate outer aperture or window 126 at an exterior surface of housing 102.

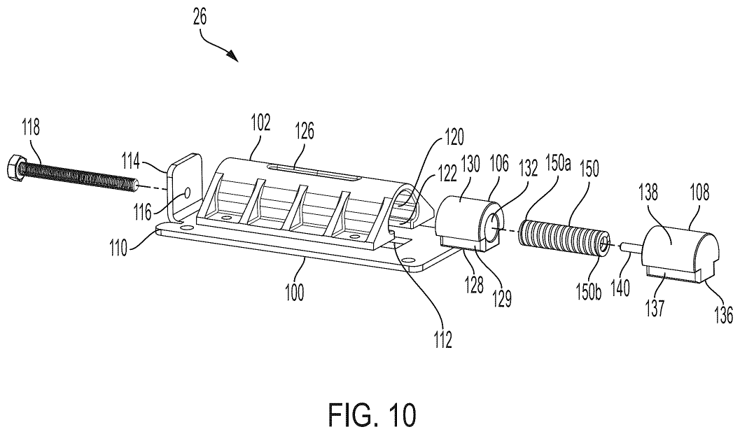

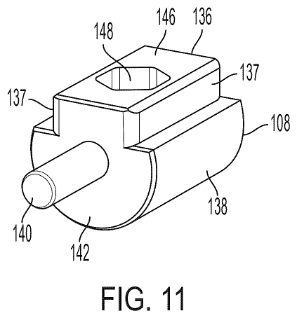

In the illustrated embodiment slides 106, 108 are shaped to have an outer profile that corresponds to the interior profile of passage 120 for constrained sliding movement within passage 120. As shown in FIGS. 9 and 10, slide 106 comprises a spring slide and includes a rectangular shaped foot 128 having sides or sidewalls 129 and includes a semicylindrical body portion 130. Slide 106 further includes an internal cavity or receptacle 132 at one end and a solid face or surface 134 at the opposite end. As shown in FIGS. 9-11, slide 108 comprises a slide mount and similarly includes a rectangular foot 136 with side walls 137, and a semicylindrical body portion 138. Slide 108 further includes a pin or dowel 140 extending from face 142 at one end of slide 108. With reference to FIG. 11, the underside 146 of slide 108 and foot 136 includes a hexagonal shaped receptacle or cavity 148. Receptacle 148 is configured to receive the hexagonal end of the shaft 152 of tension roller 32. The slide 108 of the opposed tensioner assembly 26 mounted to frame 42 likewise includes a hexagonal shaped receptacle or cavity 148 for receiving the opposite hexagonal end of the shaft 152 of tension roller 32 whereby the tension roller 32 is mounted between the pair of tensioner assemblies 26. Shaft 152 is prohibited from rotation due to the hexagonal configuration of cavities 148 and shaft 152.

A biasing extension or member that is configured as a spring 150 is configured to be connected with slides 106, 108 within housing 102, with one end 150a of spring 150 being disposed within receptacle 132 of slide 106 and the other end 150b of spring 150 being mounted over dowel 140 of slide 108 so as to press against face 142. Although the biasing member is illustrated as a coiled spring it should be appreciated that alternatively constructed biasing members may be employed, including alternatively configured, shaped or types of springs.

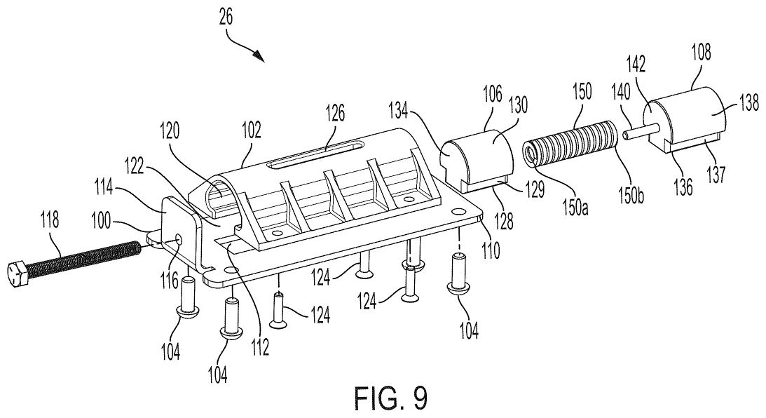

As understood from FIG. 8 the foot portion 128 of slide 106 and the foot portion 136 of slide 108 are confined within aperture 112 and are able to slidingly move within aperture 112. In particular, sidewalls 129 of foot portion 128 and sidewalls 137 of foot portion 136 slidingly contact and are restrained by the elongate side of aperture 112 as defined by the thickness of base 110. Slides 106, 108 are likewise constrained by the ends of aperture 112. Bolt 118 is mounted within hole 116 and is configured to be turned to extend bolt 118 such that the end of bolt 118 presses against face 134 of slide 106 whereby spring 150 in turn presses against face 142 of slide 108. Due to tension roller 32 being mounted between slides 108, tightening of bolts 118 at each tensioner assembly 26 on side frames 40, 42 imparts a biasing force against the belt 30 by tension roller 32 being pressed or biased there against.

As noted, tensioner assembly 26 is mounted to side frame 40 at apertures 82a-82d. When so mounted, the elongate aperture 112 of bracket 100 is positioned at the elongate aperture 83 on side frame 40. Although not illustrated, the elongate aperture 112 of the bracket 100 of the opposite tensioner assembly 26 is similarly located at the elongate aperture 83 of the side frame 42. Accordingly, with the respective ends of the shaft 152 of tension roller 32 mounted within the receptacles 148 of slides 108 of each tensioner assembly 26, the tension roller 32 may be moved within the apertures 83 of the side frames 40, 42, and thus relative to the side frames 40, 42, to impart biasing force to the conveyor belt 30 for maintaining the proper or desired tension on belt 30.

As understood from FIG. 7, slide 108 is visible through window 126 of housing 102, and in particular the end of slide 108 as defined by face 142. An operator may tighten or loosen bolt 118 to selectively apply more or less force on slide 108 and thus more or less pressing force of tension roller 32 against belt 30, where the tightening or loosening of bolt 118 will adjust the position of slide 118 within housing 102. Window 126 may thus be used for setting the tension on belt 30 as well as used to equally adjust the tension assemblies 26 on either side of conveyor 20. That is, the tension on belt 30 may be set by observing and adjusting the position of slide 108 via bolt 118, with an operator using the windows 126 on each of the opposed tension assemblies 26 to equally set the position of slide 108 via the respective bolts 118, and thus impart equal force to each end of the tension roller 32. To this end, a scale or markings may be included on housing 102 at window 126 for aiding in the positional setting of slides 108 within housings 102 of the opposed tension assemblies 26.

In the illustrated embodiment bracket 100 is formed from metal, such as by stamping, and housing 102 is formed of plastic, such as DELRIN. It should be appreciated that alternative constructions and configurations for bracket and housing may be employed within the scope of the present invention. For example, a housing may be molded or machined, and/or a bracket may be alternatively formed.

In the configuration of the illustrated embodiment of FIG. 4, driven roller 24 is disposed in a vertical arrangement so as to direct belt 30 into engagement with a lower portion of conveyor rollers 34 to the left of driven roller 32 with respect to the orientation of FIG. 5. That is, driven roller 32 is disposed so as the upper most location of the outside diameter of driven roller 32 is slightly vertically higher than the lower most location of the outside diameter of an adjacent conveyor roller 34. Still further, tension roller 32 and idler roller 36 are positioned vertically lower than driven roller 32, with idler roller 36 being outward of driven roller 32 but inward of the end roller conveyor 34h. Also in the illustrated embodiment conveyor belt 30 is illustrated as an endless conveyor belt. It should be further appreciated, however, that alternative conveyor belts may be employed, such as a laced belt.

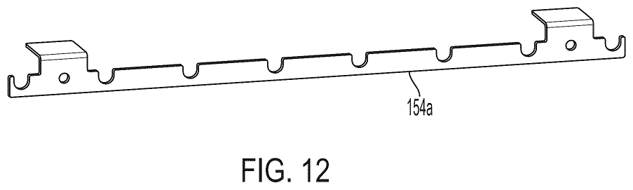

FIG. 1 discloses a pair of brackets 154a, 154b that are mounted at side frames 40, 42 of conveyor 20 on either side of and along conveyor rollers 34, with bracket 154a shown removed in FIG. 12. Similarly, brackets 156a, 156b are shown on conveyor 220 in FIG. 6. Brackets 154a, 154b, 156a, 156b are configured as guide and guard brackets that include notches associated with shafts of rollers 34 and thus vary in length depending on the number of conveyor rollers 34 employed with a given drive system.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A conveyor assembly having a conveyor belt for conveying articles, said conveyor assembly comprising:
a pair of side frames to which a belt drive system is mounted, wherein the belt is driven by the belt drive system between the side frames;
wherein the belt drive system comprises a plurality of rollers mounted between the side frames and about which the belt is disposed with the plurality of rollers comprising a driven roller, a tension roller and a plurality of conveyor rollers;
wherein the tension roller is mounted to the side frames by a tension assembly mount comprising a tensioner assembly;
wherein the tensioner assembly comprises a housing having a channel within which a slide mount is disposed for movement, with the housing including an elongate opening at the channel, and wherein the tension roller includes a shaft and an end of the shaft is engaged with the slide mount at the elongate opening;
wherein the tensioner assembly further comprises a biasing member configured to apply a force to the slide mount to thereby bias the tension roller into engagement with the belt for applying a tension force to the belt about the plurality of rollers.

2. The conveyor assembly of claim 1, wherein the tensioner assembly further comprises an adjustment shaft coupled to the biasing member for selectively adjusting the force applied to the slide mount.

3. The conveyor assembly of claim 2, wherein the tensioner assembly further comprises a bracket to which the housing is mounted with the bracket being mounted to one of the side frames, wherein the bracket comprises an elongate opening aligned with the elongate opening of the housing.

4. The conveyor assembly of claim 3, wherein the adjustment shaft is mounted to the bracket.

5. The conveyor assembly of claim 1, wherein the tensioner assembly comprises a first tensioner assembly and wherein the tension assembly mount further comprises a second tensioner assembly, wherein the first tensioner assembly is mounted to one of the side frames and the second tensioner assembly is mounted to the other of the side frames with the tension roller mounted to and between the first tensioner assembly and the second tensioner assembly.

6. The conveyor assembly of claim 5, wherein the side frames each include elongate apertures and wherein the first tensioner assembly and the second tensioner assembly are mounted to the respective side frames at the elongate apertures of the side frames with the shaft of the tension roller engaging with the first tensioner assembly and the second tensioner assembly through the elongate apertures of the side frames.

7. The conveyor assembly of claim 1, wherein the plurality of conveyor rollers comprises at least two end conveyor rollers between which the belt defines a conveying surface, and wherein the driven roller presses against an outer surface of the belt and the tension roller presses against an inner surface of the belt.

8. The conveyor assembly of claim 1, further comprising a plurality of belt drive systems and a plurality of belts, wherein each belt is driven by a separate one of the belt drive systems.

9. A belt drive system for driving a belt of a conveyor, said belt drive system comprising:
a plurality of rollers configured to be mounted between a pair of side frames of a conveyor and about which a belt is disposed with the plurality of rollers comprising a driven roller, a tension roller and a plurality of conveyor rollers;
a tension assembly mount for mounting the tension roller between the side frames, wherein the tension assembly comprises a tensioner assembly;
wherein the tensioner assembly comprises a housing having a channel within which a slide mount is disposed for movement, with the housing including an elongate opening at the channel, and wherein the tension roller includes a shaft and an end of the shaft is engaged with the slide mount at the elongate opening;
wherein the tensioner assembly further comprises a spring configured to apply a force to the slide mount to thereby bias the tension roller into engagement with the belt for applying a tension force to the belt about the plurality of rollers.

10. The belt drive system of claim 9, wherein the tensioner assembly further comprises an adjustment shaft coupled to the spring for selectively adjusting the force applied to the slide mount.

11. The belt drive system of claim 10, wherein the tensioner assembly further comprises a bracket to which the housing is mounted with the bracket comprises an elongate opening aligned with the elongate opening of the housing, and wherein the bracket is configured for mounting to one of the side frames.

12. The belt drive system of claim 11, wherein the adjustment shaft is mounted to the bracket.

13. The belt drive system of claim 9, wherein the at least one tensioner assembly comprises a first tensioner assembly and a second tensioner assembly with tension roller mounted to and between the first tensioner assembly and the second tensioner assembly, and wherein the first tensioner assembly is configured to be mounted to one of the side frames and the second tensioner assembly is configured to be mounted to the other of the side frames.

14. The belt drive system of claim 9, wherein the plurality of conveyor rollers comprises at least two end conveyor rollers between which the belt defines a conveying surface, and wherein the driven roller presses against an outer surface of the belt and the tension roller presses against an inner surface of the belt.

15. The belt drive system of claim 14, wherein a belt projection extends from the inner surface of the belt, and wherein each of the tension roller and the conveyor rollers include a groove within which the belt projection is configured to ride.

16. The belt drive system of claim 14, wherein the plurality of rollers further comprises an idler roller about which the belt is disposed.

17. A tension assembly mount assembly for applying a biasing force to a belt of a conveyor, said tension assembly mount comprising:
at least one tensioner assembly;
wherein the tensioner assembly comprises a housing having a channel within which a slide mount is disposed for movement, with the housing including an elongate opening at the channel, and wherein the slide mount is configured to receive an end of a shaft of a tension roller at the elongate opening;
wherein the tensioner assembly further comprises a spring configured to apply a force to the slide mount to thereby bias the tension roller into engagement with a belt for applying a tension force to the belt.

18. The tension assembly mount of claim 17, further comprising an adjustment shaft coupled to the spring for selectively adjusting the force applied to the slide mount.

19. The tension assembly mount of claim 18, further comprising a bracket to which the housing is mounted with the bracket comprising an elongate opening aligned with the elongate opening of the housing, wherein the adjustment shaft comprises a threaded shaft and is mounted to the bracket, and wherein the bracket is configured for mounting to a side frame of a conveyor.

20. The tension assembly mount of claim 19, wherein the housing includes an outer aperture through which the slide mount is visible for observing the position of the slide mount within the housing.

21. The tension assembly mount of claim 20, further comprising a spring slide disposed within the channel of the housing with the spring being disposed between the slide mount and the spring slide, and wherein the threaded shaft engages with the spring slide to selectively adjust the force applied to the slide mount via the spring.

22. The tension assembly mount of claim 17, wherein the at least one tensioner assembly comprises a first tensioner assembly and a second tensioner assembly configured for mounting a tension roller therebetween.
